(19) United States
(12) Patent Application Publication
(10) Pub. No.: US 2019/0159424 A1
(43) Pub. Date: May 30, 2019

(54) PET'S TOILET SEAT

(71) Applicant: Fang LIU, Beijing (CN)

(72) Inventor: Fang LIU, Beijing (CN)

(21) Appl. No.: 16/262,944

(22) Filed: Jan. 31, 2019

Related U.S. Application Data
(63) Continuation-in-part of application No. PCT/CN2017/000428, filed on Jul. 10, 2017.

(30) Foreign Application Priority Data
Aug. 3, 2016 (CN) 201620834108.5

(51) Int. Cl. A01K 1/01

(52) U.S. Cl. CPC A01K 1/0121; A01K 1/011

(57) ABSTRACT

A pet's toilet seat is for the pets defecating at home and after they have defecated, their excrement can be directly washed away via the closestool, so it is very environmental and practical. It is easy to use: at first the first seat is connected to the closestool and then the second seat is disposed on the first seat and the cover is disposed on the second seat and can be opened. The pets can sit on the second seat to defecate, and the excrement can fall into the second seat's hole. The first seat which the pet owner uses is very clean, because the dirty things on the pets' feet can't fall down to the first seat.

### CROSS REFERENCE TO RELATED APPLICATIONS

This application is the continuation-in-part application of International Application No. PCT/CN2017/000428, filed on Jul. 10, 2017, which is based upon and claims priority to Chinese Patent Application No. 201620834108.5, filed on Aug. 3, 2016, the entire contents of which are incorporated herein by reference.

### TECHNICAL FIELD

The present invention relates to the field of the closestool, and in particular, to a pet's toilet seat.

BACKGROUND

CN2593718Y discloses a toilet seat for children. The difference between this pet's toilet seat and the cited document of the background is: The hole of the second seat of the cited document is very front, so that the pet can't use it. And it is very dirty for the other users, so that the other people can't use it with the pet together. Anyhow the toilet seat for children is very different to the toilet seat for pet.

### SUMMARY

A pet's toilet seat is for the pets defecating at home and after they have defecated, their excrement can be directly washed away via the closestool, so is very environmental and practical. It is easy to use: at first, connect the first seat with the closestool together and then the second seat is on the first seat and the cover is on the second seat and it should be open. Because the second seat's hole is smaller than the first seat's and the outside edge of second seat is bigger than the first seat's and can cover over the first seat's, therefore the pet can seat on the second seat to defecate, the excrement can fall into the second seat's hole. The first seat, which the pet owner uses is very clean, because the dirty things on the pet's foods can't fall down to the first seat. The cover on the second seat is also useful, because after practiced the pets can automatically close the cover after they have defecated. After the pet owner found the cover is closed, he can know he should come to wash away the excrement. If the wash-button on the closestool is enough big, after practiced the pet can also directly wash the excrement away itself. Normally, at the beginning of the practice, the pet owner needs just to put some pet's urine into the closestool, so that the pets can well know where they should defecate. But if for some pets it is not successful, the pet owner can also paste a small piece of toilet paper on the back of the second seat's hole and put some pet's urine onto the toilet paper. For the second seat and the cover they all have protecting films. The second seat's protecting film's stuff is plastic film or leatherette. The cover's protecting film's stuff is also plastic film or leatherette. If sometimes the pet's excrement doesn't fall into the hole but a little stayed, it can't pollute the second seat and the cover, because they all have protecting films, the pet owner should just only wash or wipe the films, and the stuff can be plastic or leatherette, because such stuff can be guarded against biting. The pet owner can change either the films all to new films, or just only wash or wipe the films.

### BRIEF DESCRIPTION OF THE DRAWINGS:

FIG. 1 is a schematic diagram of a first embodiment according to the present invention;

FIG. 2 is a schematic diagram of a second embodiment according to the present invention; and

FIG. 3 is a schematic diagram of a third embodiment according to the present invention.

In the figures: 101 is the first seat, 102 is the second seat, 103 is the cover ,104 is outside edge of 102,105 are hook-and-loop fasteners, 106 is hinge-axis, 108 are clips of 102, 109 are casing pipes, 110 is the pipe, 111 is the cover of 106.

### DETAILED DESCRIPTION OF THE EMBODIMENTS:

The following further explains the present invention with reference to the accompanying drawings.

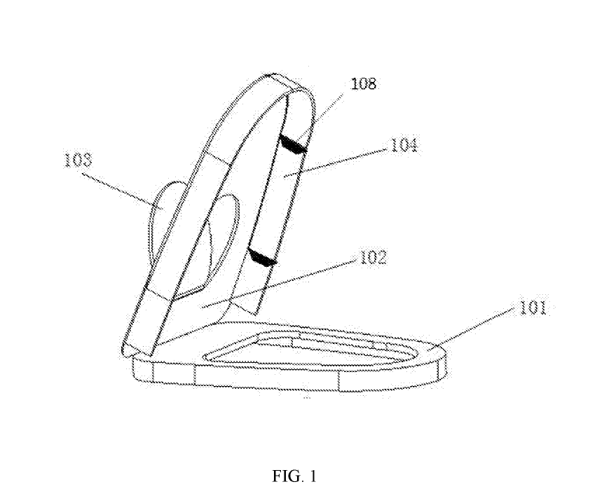

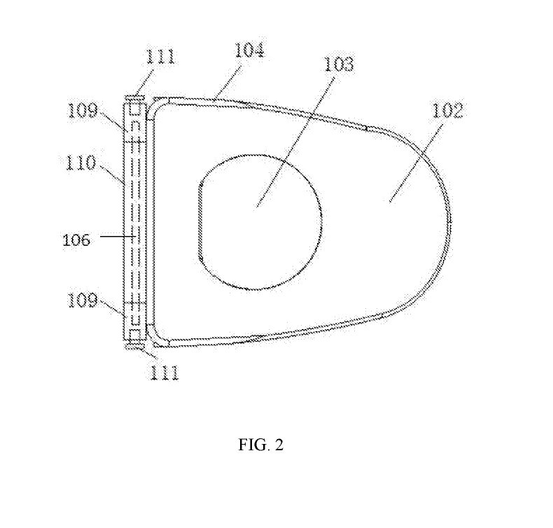

1:As show in FIG. 1.and FIG. 2, the pet's toilet seat includes: the first seat 101,the second seat 102 and the cover 103. The first seat 101 is connected to the closestool, the second seat102 is connected to the first seat 101, and the second seat 102 is disposed on the first seat 101, the hole of the second seat 102 is smaller than that of the first seat 101, the second seat 102 has outside edge 104, the outside edge 104 can cover over the first seat 101. The cover 103 is disposed on second seat 102, and the cover 103 can cover the hole of the second seat 102. The pet can seat on the second seat 102 to defecate and it doesn't influence the pet owner to use the first seat 101. After the pet has defecated, it can also close the cover 103.

In detailed description of the first embodiment: the first seat 101 and the second seat 102 hinge with each other via hinge-axis 106, the hinge-axis 106 is removable. As show in FIG. 2, the first seat 101 connected to the casing pipes 109. There are two casing pipes 109 casted with the closestool together. The second seat 102 has pipe 110. The pipe 110 is in the middle of two casing pipes 109. The hinge-axis 106 is the axis of the casing pipes 109 and the pipe110, the hinge-axis 106 is through both of the casing pipes 109 and the pipe 110. At both sides of the pipe 106, there are two covers 111. If the two covers 111 are taken off, the hinge-axis 106 can be drawn out completely. If a user wants to change the second seat 102, the user should at first take two covers 111 off and then draw the hinge-axis 106 out, then the user can change the second seat102 (in case that the user wants to change to a bigger size), and then after the user have changed, the stick 106 should be back and the two covers 111 should be closed. So the interior of the two casing pipes 109 can have screw thread and the two covers 111 can have also the suitable screw thread. If the user wants to change the first seat 101 is also by the same way, the user must draw the stick 106 out. The cover 103 and the second seat 102 also hinge with each other, and if cover 103 and the second seat hinge with each other, there must be also a hinge-axis, then cover 103 can be also removable (by the same way), but normally at the beginning the user don't need to take the cover 103 off.

Detailed description of the second embodiment. The second embodiment has described another connecting mothed between the first seat 101 and the second seat 102. As show in FIG. 1, on the back of the outside edge of the second seat 102 (also inside from the outside edge 104), there are some clips 108 and the clips 108 can seize up the first seat 101. Every time if the user wants to take the second seat 102 off, the user should use a little power to draw the second seat 102 out, and if the user wants to put the second seat 102 back, the user should also use a little power to seize it up.

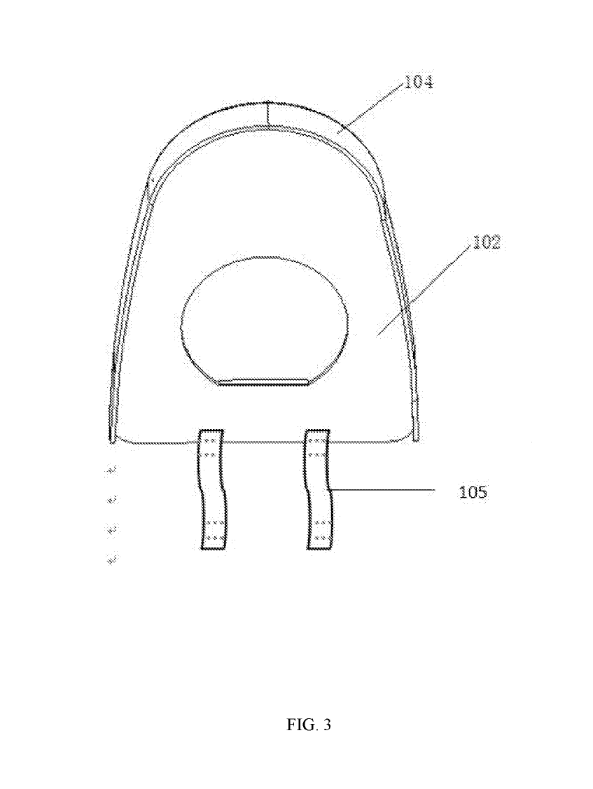

Detailed description of the third embodiment. The third embodiment has described another connecting mothed between the first seat 101 and the second seat 102. As show in FIG. 3, on the back and almost at the tail of the second seat 102, there are two long hook-and-loop fasteners 105 and the hook-and-loop fasteners 105 can go around the whole back side of the first seat 101 and then return back paste on each other on the hook-and-loop fasteners 105. Except the hook-and-loop fasteners 105, the connecting part can be also two long bands with snap fasteners.

What is claimed is:

1. A pet's toilet seat , comprising: a first seat, a second seat and a cover; wherein the first seat is connected to a closestool, and also connected to the second seat, the second seat is disposed on the first seat, and a hole of the second seat is smaller than a hole of the first seat and an outside edge of the second seat is bigger than an outside edge of the first seat, and the outside edge of the second seat covers over the outside edge of the first seat, the second seat is also connected to the cover, and the cover is disposed on the second seat, and the cover covers the hole of the second seat.

2. The pet's toilet seat according to claim 1, wherein the first seat and the second seat hinge with each other via hinge-axis.

3. The pet's toilet seat according to claim 1, wherein the first seat is removablely connected to the second seat.

4. The pet's toilet seat according to claim 3, wherein a plurality of fasteners are disposed on the back of the outside edge of the second seat configured for seizing up the first seat.

5. The pet's toilet seat according to claim 3, wherein the first seat and the second seat connect with each other via connecting bands.

6. The pet's toilet seat according to claim 1, wherein the first seat is removablely connected to the closestool.

7. The pet's toilet seat according to claim 1, wherein the second seat has a seat's protecting film.

8. The pet's toilet seat according to claim 7, wherein the seat's protecting film is made of plastic film or leatherette.

9. The pet's toilet seat according to claim 1, wherein the cover has cover's protecting film, and the cover's protecting film is made of plastic film or leatherette.

10. The pet's toilet seat according to claim 1, wherein the cover and the second seat are hinged and removablely connected.
